(19) United States
(12) Patent Application Publication
(10) Pub. No.: US 2006/0169021 A1
(43) Pub. Date: Aug. 3, 2006

(54) Method and apparatus for calibration of a motion sensing device in a portable apparatus

(76) Inventor: D. Amnon Silverstein, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/046,060

(22) Filed: Jan. 28, 2005

(51) Int. Cl. G01P 21/00; A63B 5/11

(52) U.S. Cl. 73/1.37

(57) ABSTRACT

A method and apparatus for calibrating a motion sensing device in a portable apparatus includes sampling an output of a secondary motion sensing device and determining if the output of the secondary motion sensing device is indicative of a stationary portable apparatus. If the output of the secondary motion sensing device is indicative of a stationary portable apparatus, a bias offset of a primary motion sensing device is determined from an output of the primary motion sensing device. The output of the primary motion sensing device is adjusted to remove the effects of the bias offset.

### BACKGROUND OF THE INVENTION

The present invention generally relates generally to sensing motion of a portable apparatus, and more particularly, to the calibration of motion sensing devices used in portable apparatuses.

Motion sensing devices that are operable in free space (e.g., operable independent of a fixed spatial reference point or surface) are commonly used to detect movement, such as acceleration or rotation, of a portable apparatus. The detection of movement of portable apparatuses is in general useful for many purposes. The detection of rotational movement is particularly useful when the portable apparatus is used as a pointing device to control movement of a remote element.

As one example of a portable apparatus used as a pointing device, digital cameras have been developed in which the camera is used as a pointing device. The motion of the camera is detected, and the camera motion is then used to position graphic elements on the camera's display. One application involves using the camera like a gun-sight to select images from a sheet of low-resolution (“thumbnail”) images shown on the camera's display. The motion of the camera is tracked and, by moving the camera, the user aims a pointer at the desired image from the sheet of thumbnail images. The user is thus able to select a thumbnail image from a sheet of images in an intuitive manner by simply pointing the camera at the desired thumbnail image. Accurate detection and tracking of movement of the camera is important to allow precise control by the user.

Motion of a portable apparatus can be detected in many different manners. Exemplary motion sensing devices useful in free space include gyroscopic elements, tilt sensors, accelerometers, compasses, and GPS receivers, for example. When the portable device is a camera, motion of the camera can also be detected and tracked by optical flow, wherein the camera records a sequence of images, compares the sequential images with each other, and estimates motion based upon the compared images.

Many motion sensing devices must be periodically calibrated. Calibration can be required for several reasons. Some motion sensing devices may not function or may lose their accuracy when not continuously supplied with power, and calibration of such devices is necessary each time the device is powered off and on, upon replacement of batteries, and so on. Other motion sensing devices can develop or accumulate sensing errors over an extended period of time, and recalibration is necessary or desirable to correct the accumulated sensing errors. For example, when gyroscopes are used to detect rotational motion, gyroscopic drift is a common problem. That is, the heading of the gyroscope does not remain stable. As a result, an output signal of the gyroscope indicates motion when no motion is actually occurring. Errors in the gyroscope heading slowly accumulate and the heading wanders, typically in a constant direction or in a direction that is slowly changing. In an application like that described above, where motion of a camera is tracked to aim a pointer, gyroscopic drift will cause the pointer to move even when the camera is stationary, or cause the pointer to move in a direction different than the actual movement of the camera.

Accordingly, the ability to reliably and accurately calibrate a motion sensing device in a portable apparatus is desirable.

### SUMMARY OF THE INVENTION

The invention described herein provides a method and apparatus for calibrating a motion sensing device in a portable apparatus. In one embodiment, wherein the portable apparatus includes a primary motion sensing device and a secondary motion sensing device, the method comprises sampling an output of the secondary motion sensing device and determining if the output of the secondary motion sensing device is indicative of a stationary portable apparatus. In response to the output of the secondary motion sensing device being indicative of a stationary portable apparatus, a bias offset of the primary motion sensing device is determined from an output of the primary motion sensing device. The output of the primary motion sensing device is then adjusted to remove the effects of the bias offset.

In one implementation, the portable apparatus is a camera having a display. The camera includes a primary motion sensor providing an output indicative of camera motion. Display circuitry displays a cursor and a scene on the display, and repositions the scene in the display based on the primary motion sensor output. Calibration circuitry determines a bias offset of the primary motion sensor, and adjusts the primary motion sensor output to remove the effects of the bias offset.

### BRIEF DESCRIPTION OF THE DRAWINGS

FIG. 1 is a block diagram of an exemplary portable apparatus having a motion detection unit, according to one embodiment of the invention.

FIG. 2 is a flow chart illustrating the method of the present invention.

FIG. 3 is a flow chart illustrating an exemplary implementation of the method of FIG. 2.

FIG. 4A is a block diagram illustrating an exemplary embodiment of the motion detection unit of FIG. 1, showing a primary motion sensing device and a secondary motion sensing device for providing a primary output signal and a secondary output signal, respectively.

FIG. 4B is an exemplary graph of the primary output signal and secondary output signal using the motion detection unit embodiment of FIG. 4A.

FIG. 5A is a block diagram illustrating another exemplary embodiment of the motion detection unit of FIG. 1, showing a primary motion sensing device and a signal processing unit for providing a primary output signal and a secondary output signal, respectively.

FIG. 5B is an exemplary graph of the primary output signal and secondary output signal using the motion detection unit embodiment of FIG. 5A.

### DESCRIPTION OF THE PREFERRED EMBODIMENT

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

The invention will be described primarily with reference to exemplary implementations in a camera, where motion sensing information from a sensing device is used to control information on a display. However, it is understood that the invention may be implemented with any portable device having a motion detection unit. Further, the motion sensing information can be used for many applications beyond that of controlling a remote element such as a screen image or the like.

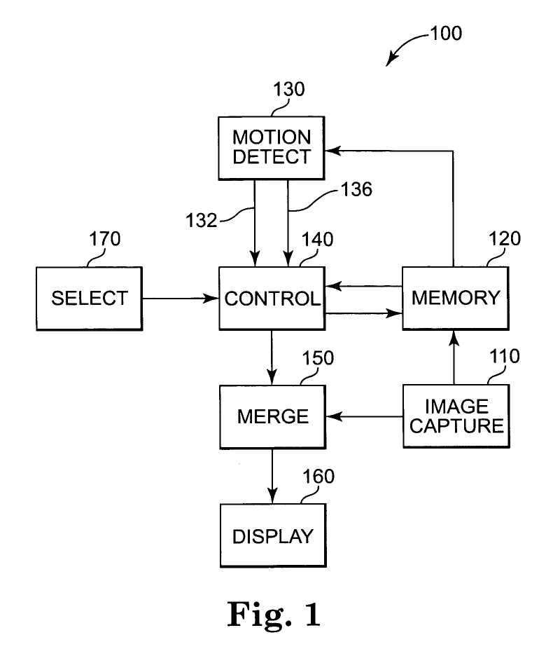

FIG. 1 is a block diagram of one implementation of a portable apparatus 100 having a motion detection unit 130 according to the invention. The portable apparatus 100 in FIG. 1 is used as a pointing device to control a graphical user interface on a display 160. One embodiment of the portable apparatus 100 of FIG. 1 could be a digital camera having a display. In other embodiments, the portable apparatus 100 could be a personal digital assistant (PDA), cellular telephone, or other device having a display. In portable apparatus 100, an image is captured by an image capture unit 110. The image capture unit 110 can be selected from among any such device known in the art, such as a CCD or CMOS imaging device, as are commonly used for image sensing in modern digital cameras. One or more of a series of images captured by image capture unit 110 are stored at least temporarily in memory 120.

The motion detection unit 130 senses motion of portable apparatus 100. The motion detection unit 130 provides a primary output signal 132 indicative of at least rotational movement (pitch, yaw and/or roll) of the portable apparatus 100. Depending upon requirements of the particular implementation, the output signal 132 may be indicative of one or more of pitch, yaw and roll of the portable apparatus 100. The motion detection unit 130 further provides a secondary output signal 136, also indicative of movement of the portable apparatus 100. The secondary output signal 136 may be indicative of any type of movement of the portable apparatus 100, including linear movement, rotational movement, or both. However, secondary motion output signal 136 need not have the ability to quantify the detected movement, either in terms of direction or magnitude.

The primary output signal 132 and secondary output signal 136 are provided to control unit 140. The control unit 140 causes a merge unit 150 to combine the rotational motion sensing information of the primary output signal 132 with previously captured images from memory 120 and/or real-time images from image capture unit 110. The combined information is displayed on a display 160.

In an exemplary implementation, the rotational motion sensing information of the primary output signal 132 is represented on the display 160 by a cursor, and is combined on the display 160 with one or more icons, such as a sheet of previously captured thumbnail images stored in memory 120. The control unit 140, using software and/or circuitry, displays the cursor and a scene on the display 160, and repositions the scene in the display 160 based on the primary output signal 132. The control unit 140, using software and/or circuitry, further determines the bias offset of the primary output signal 132 and adjust the primary output signal 132 to remove the effects of the bias offset. In one embodiment, the cursor is a cross-hair that is always fixed relative to the portable apparatus (e.g., the cross hair cursor always appears in the center of the display 160). As the portable apparatus 100 is turned or rotated by the user, the thumbnail images are repositioned within the display 160 such that cross-hair cursor moves across the thumbnail images, and the thumbnail images appear motionless with respect to the world. When the desired icon moves under the cursor, the user can select this target icon using a selection unit 170. The image manipulation and operation of the exemplary pointing device is further described in co-pending U.S. patent application Ser. No. 10/693,446, filed Oct. 23, 2003, having common inventorship and commonly assigned herewith, which is incorporated by reference in its entirety.

In some embodiments, display 160 may be integral with portable apparatus 100 and comprise a viewfinder micro-display or a panel display as are well known in the art. In other embodiments, display 160 may comprise a remote display that is in communication with the portable apparatus 100, such as a television or computer monitor. Selection unit 170 may comprise a selection switch or button, a voice command detection system, or any other suitable form of selection known in the art.

Over a period of time, the motion detection unit 130 may accumulate sensing errors such that the primary output signal 132 does not accurately reflect the actual rotational movement of the portable apparatus 100 (e.g., the signal 132 has a “bias offset”). Eventually, the accumulated sensing errors may grow to a magnitude that negatively impacts the operation of the portable apparatus 100. The time period required before the bias offset negatively impacts the portable apparatus operation may range from several minutes to several days or longer.

To overcome or reduce the problem of accumulated sensing errors, the primary output signal 132 is periodically recalibrated. Specifically, when the motion detection unit 130 of the portable apparatus 100 is known to be at rest, the bias offset of the primary output signal 132 is measured. The measured bias offset is then subsequently removed from the primary output signal 132, such that the primary output signal 132 accurately represents movement of the portable apparatus 100.

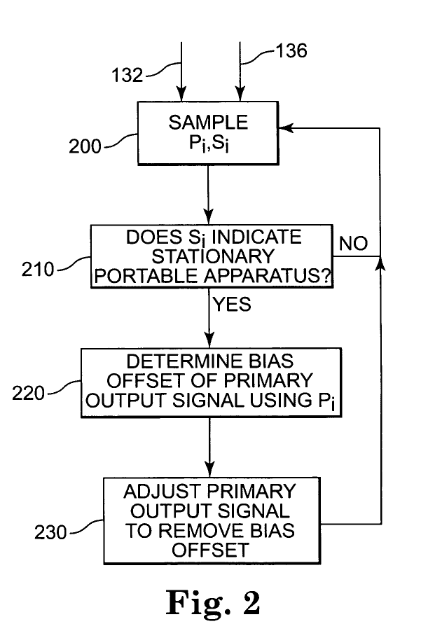

Referring to FIG. 2, the primary output signal 132 and the secondary output signal 136 are periodically sampled (step 200), with each primary output signal sample Pᵢ having a corresponding secondary output signal sample Sᵢ. The secondary output signal 136 is used to determine if the portable apparatus is stationary or moving (step 210). In one implementation, the controller 140, using software and/or circuitry, determines if the secondary output signal 136 is indicative of a stationary portable apparatus by comparing the value of the sample Sᵢ from secondary output signal 136 to a predetermined threshold value T. If the value of the sampled secondary output signal 136 falls below the threshold T (i.e., Sᵢ<T) then the portable apparatus is determined to be stationary (a “stationary sample”). If the value of the sampled secondary output signal 136 exceeds the threshold T (i.e., Sᵢ>T), then the portable apparatus is determined to be moving (a “moving sample”). The threshold value T may be selected such that the portable apparatus does not have to be absolutely still for a sampled secondary output signal 136 to fall below the threshold value. In some implementations, a small amount of movement of the portable apparatus may be tolerated when recalibrating the primary output signal 132.

In response to at least a portion of the secondary output signal 136 being indicative of a stationary portable apparatus, a bias offset of the primary output signal 132 is determined. The bias offset is determined from an average of the primary output signal 132 that corresponds to the portion of the secondary output signal 136 that is indicative of a stationary portable apparatus (step 220). That is, for the samples Sᵢ of secondary output 136 determined to be “stationary samples”, the corresponding samples Pᵢ of primary output 132 are averaged to determine the bias offset of the primary output signal 132. If no bias offset is present, the average will be zero.

In some implementations, the portions of primary output signal 132 used to determine the bias offset may not include primary output signal occurring within a predetermined time period from secondary output signal indicative of a non-stationary portable apparatus. That is, samples Pᵢ of primary output signal 132 that are close in time to “moving samples” of secondary output signal 136 may be omitted from the bias offset determination. In this manner, it can be assured that the portable apparatus has been still for a period of time sufficient to allow settling of the primary output signal 132.

After the bias offset has been determined, the primary output signal 132 is then adjusted to remove the effects of the determined bias offset (step 230).

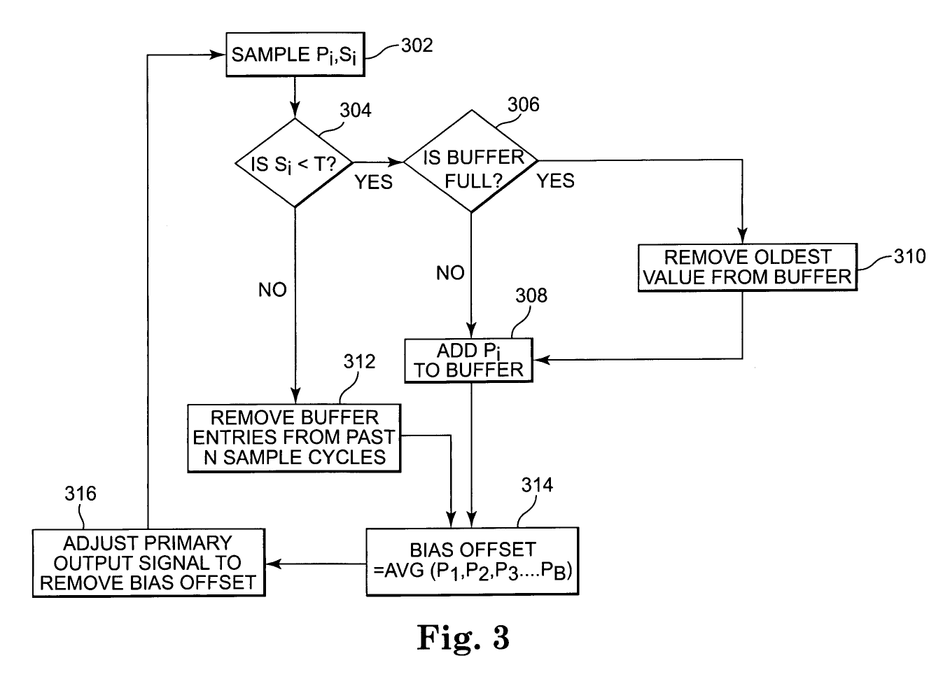

In one embodiment, a buffer having a buffer size, B, is used to store samples Pᵢ from the primary output 132 (FIG. 3). The bias offset of the primary output signal 132 is determined by averaging the values of P₁ through P_{B} in the buffer. In step 302, primary output signal 132 and secondary output signal 136 are sampled to obtain samples Pᵢ, and Sᵢ, respectively. The value of sample Sᵢ is compared to a threshold value T in step 304. If Sᵢ<T (i.e., a stationary sample), the buffer is checked to determine if the buffer is full in step 306. If the buffer is not full, then the sample Pᵢ is placed in the buffer in step 308. If the buffer is full, the oldest sample in the buffer is removed in step 310, and then the sample Pᵢ is placed in the buffer in step 308. In step 304, if Sᵢ>T (i.e., a moving sample), then values from the past N samples are removed from the buffer in step 312, where N is the number of samples away from any movement that are required for the sample data to be useful. In step 314, the bias offset of the primary output signal 132 is determined by averaging the values of P₁ through P_{B} in the buffer. New samples Pᵢ, Sᵢ are then taken and the process repeated. In step 316, the primary output signal 132 is adjusted to remove the effects of the bias offset. The average value of the buffer values P₁ through P_{B} may be continuously recalculated to provide an accurate bias offset.

Using the above-described method to determine the bias offset of the primary output signal 132 allows the portable apparatus to have a very recent calibration, because any time the portable apparatus 100 is stationary, the bias offset is automatically updated.

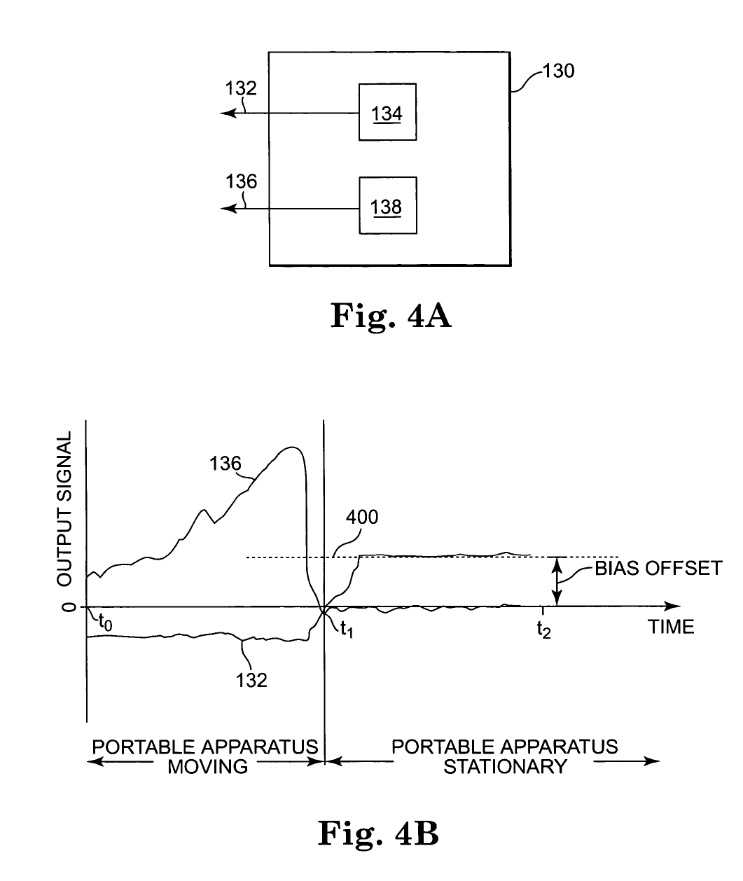

Referring to FIG. 4A, one exemplary implementation of motion detection unit 130 is illustrated in which the primary output signal 132 and secondary output signal 136 are provided by a primary motion sensing device 134 and a secondary motion sensing device 138, respectively. The primary motion sensing device 134 is sensitive to rotational movement of the portable apparatus, and the corresponding primary output signal 132 is accordingly indicative of rotational movement of the portable apparatus. In some implementations, the primary motion sensing device 134 comprises a gyroscope or gyroscopic element, and may include more than one gyroscope or gyroscopic element to provide pitch, yaw and/or roll information.

The secondary motion sensing device 138 may be sensitive to any type of movement of the portable device. The corresponding secondary output signal 136 need only be indicative of absolute movement of the portable apparatus, and need not have the ability to quantify detected movement, either in terms of direction or magnitude. The secondary motion sensing device 138 is preferably of a type resistant to accumulated sensing errors. In some implementations, the secondary motion sensing device 138 is an optical sensor that uses the changes between subsequent images captured by image capture unit 110 to sense motion of portable apparatus 100. In other implementations according to the invention, the secondary motion sensing device 138 uses non-optical motion sensing techniques and devices as are known in the art, such as accelerometers, tilt sensors, and GPS receivers, for example. The secondary motion sensing device 138 may include more than one motion sensing element. For example, secondary motion sensing device 138 may comprise two or more accelerometers measuring acceleration along two or more axes of the portable apparatus 100.

In FIG. 4B, an exemplary graph is presented, illustrating a primary output signal 132 and a secondary output signal 136, where the primary output signal 132 is provided by a primary output device 134 such as a gyroscope, and the secondary output signal 136 is provided by a secondary output device 138, such as an accelerometer. Signal strengths different than 0 are indicative of movement of the portable device 100. As can be seen from the graph, the secondary output signal 136 indicates the portable apparatus 100 is moving from time t₀ to time t₁, and is stationary or moving only slightly after time t₁. However, primary signal output 132 indicates the portable apparatus 100 is still moving after time t₁. The average value of primary output signal 132 after time t₁, is the bias offset of primary output signal 132. Using the bias offset, the value of the primary output signal 132 can be recalibrated to establish a new zero after time t₁, indicated by dashed line 400.

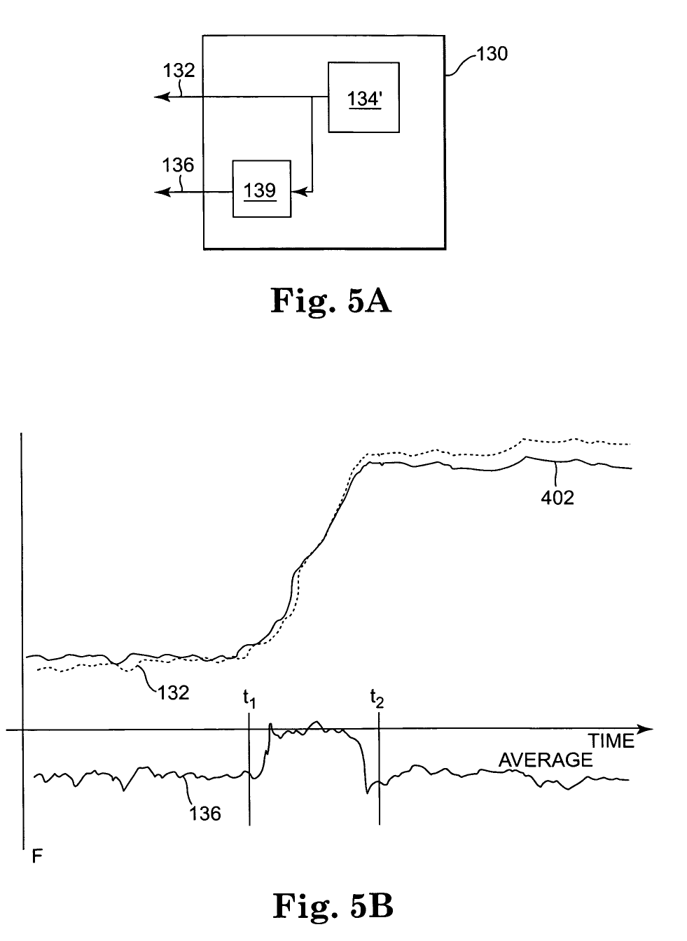

Referring to FIG. 5A, another exemplary implementation of motion detection unit 130 is illustrated in which the primary output signal 132 and secondary output signal 136 are both obtained from a single primary motion sensing device 134′. The primary motion sensing device 134′ is sensitive to rotational movement of the portable apparatus. The primary output signal 132 is accordingly indicative of rotational movement of the portable apparatus. The secondary output signal 136 is the derivative of the primary output signal 132, and is indicative of when the portable apparatus is undergoing significant movement. A signal processing unit 139 processes primary output signal 132 to produce secondary output signal 136. In some implementations, the primary motion sensing device 134′ comprises a gyroscope or gyroscopic element, and may include more than one gyroscope or gyroscopic element to provide pitch, yaw and/or roll information.

In FIG. 5B, an exemplary graph is presented, illustrating a primary output signal 132 and a secondary output signal 136, where the primary output signal 132 is provided by a primary output device 134 such as a gyroscope, and the secondary output signal 136 is a derivative of the primary output signal 132. The rapidly changing curve of the primary output signal 132 between time t₁, and time t₂ is representative of the portable device 100 being rotated, while the relatively flat curve of the primary output signal 136 before time t₁, and after time t₂ is representative of the portable device 100 in a relatively stable orientation. As can be seen from the graph, when the portable apparatus 100 is moving significantly (i.e., between time t₁, and time t₂), the secondary output signal 136 forms a step-like shape that is easily identified. The bias offset of the primary output signal 132 can be determined from an average of the portion of the primary output signal 132 that corresponds to the portion of the secondary output signal 136 that is indicative of a stationary portable apparatus. Thus, in the example of FIG. 5B, the portion of the primary output signal 132 between time t₁ and time t₂ is omitted when determining the bias offset of the primary output signal 132. In FIG. 5B, the recalibrated primary signal output is shown by the line 402.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electro-mechanical, and electrical arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method for calibrating a primary motion sensing device in a portable apparatus, wherein the portable apparatus includes a secondary motion sensing device, the method comprising:
sampling an output of the secondary motion sensing device;
determining if the output of the secondary motion sensing device is indicative of a stationary portable apparatus; and
in response to the output of the secondary motion sensing device being indicative of a stationary portable apparatus, determining a bias offset of the primary motion sensing device from an output of the primary motion sensing device; and
adjusting the output of the primary motion sensing device to remove the effects of the bias offset.

2. The method of claim 1, wherein determining if the output of the secondary motion sensing device is indicative of a stationary pointing apparatus comprises comparing the output of the secondary motion sensing device to a threshold value indicative of a stationary portable apparatus.

3. The method of claim 1, wherein determining a bias offset of the primary motion sensing device comprises averaging the output of the primary motion sensing device over a period of time for which the output of the secondary motion sensing device is indicative of a stationary portable apparatus.

4. The method of claim 1, wherein sampling an output of the secondary motion sensing device comprises sampling an output of an accelerometer.

5. The method of claim 1, wherein sampling an output of the secondary motion sensing device comprises sampling an output of an image tracking sensor.

6. A method for calibrating a motion detection unit in a portable apparatus, the motion detection unit supplying a primary output signal and a secondary output signal, the method comprising:
sampling the primary output signal and the secondary output signal;
determining if at least a portion of the secondary output signal is indicative of a stationary portable apparatus;
in response to at least a portion of the secondary output signal being indicative of a stationary portable apparatus, determining a bias offset of the primary output signal from an average of the primary output signal that corresponds to the portion of the secondary output signal that is indicative of a stationary portable apparatus; and
adjusting the primary output signal to remove the effects of the bias offset.

7. The method of claim 6, wherein determining if at least a portion of the secondary output signal is indicative of a stationary portable apparatus comprises comparing the secondary output signal to a threshold value.

8. The method of claim 6, wherein sampling a secondary output signal comprises sampling a derivative of the primary output signal.

9. The method of claim 8, wherein determining if at least a portion of the secondary output signal is indicative of a stationary portable apparatus comprises comparing the derivative of the primary output signal to a threshold value.

10. The method of claim 6, wherein determining a bias offset of the primary output signal from an average of the primary output signal that corresponds to the portion of the secondary output signal that is indicative of a stationary portable apparatus comprises omitting from the average of the primary output signal any primary output signal occurring within a predetermined time period from secondary output signal indicative of a non-stationary portable apparatus.

11. The method of claim 6, wherein sampling the primary output signal comprises sampling an output of a primary motion sensing device, and wherein sampling the secondary output signal comprises sampling an output of a secondary motion sensing device.

12. A method for a portable apparatus having a display, the process comprising:
displaying a cursor and a scene in the display;
moving the portable apparatus;
sensing motion of the portable apparatus using a motion sensing device;
determining if an output of the motion sensing device is indicative of a stationary portable apparatus or a non-stationary portable apparatus;
in response to an output indicative of a stationary portable apparatus, determining a bias offset of the motion sensing device; and
adjusting the output of the motion sensing device to remove the effects of the bias offset.

13. The method of claim 12, wherein determining if the output signal is indicative of a stationary camera or a non-stationary portable apparatus includes sampling a primary output of the motion sensing device and a secondary output of the motion sensing device.

14. The method of claim 13, wherein determining if the output signal is indicative of a stationary portable apparatus or a non-stationary portable apparatus comprises comparing the secondary output to a threshold value.

15. The method of claim 12, further comprising, in response to an output indicative of a non-stationary portable apparatus, repositioning the scene in the display based on sensed motion of the portable apparatus;

16. The method of claim 14, wherein determining a bias offset of the motion sensing device comprising averaging a portion of the primary output that corresponds to the secondary output indicative of a stationary portable apparatus.

17. The method of claim 13, wherein secondary output is a derivative of the primary output.

18. The method of claim 13, wherein the primary output is provided by a primary sensing device and the secondary output is provided by a secondary sensing device.

19. An apparatus having a display, the apparatus comprising:
a primary motion sensor providing an output indicative of apparatus motion;
display circuitry to display a cursor and a scene on the display, wherein the display circuitry repositions the scene in the display based on the primary motion sensor output; and
calibration circuitry to determine a bias offset of the primary motion sensor and adjust the primary motion sensor output to remove the effects of the bias offset.

20. The apparatus of claim 19, wherein the calibration circuitry determines the bias offset of the primary motion sensor only if the apparatus is substantially stationary.

21. The apparatus of claim 20, further comprising:
a secondary motion sensor providing an output indicative of apparatus motion; and
wherein the calibration circuitry includes a comparison means for comparing the output of the secondary motion sensor to a predetermined threshold.

22. The apparatus of claim 21, wherein the calibration circuitry includes means for averaging the output of the primary motion sensor over a period of time for which the output of the secondary motion sensor falls below the predetermined threshold.

23. The apparatus of claim 21, wherein at least one of the primary motion sensor and the secondary motion sensor comprise an inertial sensor.

24. The apparatus of claim 23, wherein the inertial sensor is selected from the group comprising a gyroscopic device and an accelerometer.

25. The apparatus of claim 21, wherein at least one of the primary motion sensor and the secondary motion sensor comprise an optical motion sensor.

26. The apparatus of claim 19, wherein the apparatus is selected from the group consisting essentially of cameras, personal digital assistants (PDAs), and cellular telephones.

27. A portable apparatus comprising:
means for providing a primary output signal and secondary output signal indicative of apparatus movement;
means for determining if a portion of the secondary output signal is indicative of a stationary portable apparatus;
means for determining a bias offset of the primary output signal from an average of the primary output signal that corresponds to a portion of the secondary output signal that is indicative of a stationary portable apparatus;
means for adjusting the primary output signal to remove the effects of the bias offset.

28. A computer-readable storage medium containing a set of instructions for calibrating a motion detection unit in a portable apparatus, the motion detection unit supplying a primary output signal and a secondary output signal, the instructions comprising:
a sampling routine operatively associated with motion detection unit for sampling the primary output signal and the secondary output signal;
a comparison routine for comparing the secondary output signal to a threshold value indicative of a stationary portable apparatus;
an averaging routine for determining a bias offset of the primary output signal from an average of the primary output signal that corresponds to a portion of the secondary output signal that is indicative of a stationary portable apparatus; and
a calibration routine operative coupled with the motion detection unit for adjusting the primary output signal to remove the effects of the bias offset.
